(19) United States
(12) Patent Application Publication
(10) Pub. No.: US 2022/0149956 A1
(43) Pub. Date: May 12, 2022

(54) MANAGING INTERFERENCE IN COMPUTING SYSTEMS

(71) Applicant: Hewlett-Packard Development Company, L.P., Spring, TX (US)

(72) Inventors: Fei Ming Chang, Taipei City (TW); Ching-Ming Wang, Taipei City (TW); Ko Kun Tung, Taipei City (TW)

(73) Assignee: Hewlett-Packard Development Company, L.P., Spring, TX (US)

(21) Appl. No.: 17/297,800

(22) PCT Filed: Jul. 29, 2019
(86) PCT No.: PCT/US2019/043996

§ 371 Date: May 27, 2021

(51) Int. Cl. H04B 15/00; H04B 15/02; G06F 1/04; G06T 1/20; G09G 5/00; G09G 5/18

(52) U.S. Cl. CPC H04B 15/005; H04B 15/02; G09G 5/18; G06T 1/20; G09G 5/006; G06F 1/04

(57) ABSTRACT

Techniques for manging interference in computing systems are described. In operation, an electromagnetic signal experienced by the computing system is detected. A strength of the electromagnetic signal is then determined to be above a predetermined threshold. Based on the determination, a voltage swing across a driver IC of an electronic component of the computing system is increased.

### BACKGROUND

Computing systems are generally made up of multiple electronic components that are assembled together to perform various predefined functions of the computing system. In the computing systems, each electronic component is configured to operate at a certain frequency, also known as frequency of operation of the electronic component. The frequency of operation is the rate in cycles per unit time at which the electronic component performs its different operations. For instance, a display panel of a computing system that displays 60 frames per second is defined to have an operational frequency of 60 Hz.

### BRIEF DESCRIPTION OF DRAWINGS

FIG. 1 illustrates a computing system, in accordance with an example of the present subject matter,

FIG. 2 illustrates a computing system, in accordance with another example of the present subject matter,

FIG. 3 illustrates a computing system, in accordance with yet another example of the present subject matter,

FIG. 4 illustrates a method for managing interference in operation of an electronic component of a computing system, in accordance with an example of the present subject matter, and

FIG. 5 illustrates a method for managing interference in operation of an electronic component of a computing system, in accordance with another example of the present subject matter.

### DETAILED DESCRIPTION

In computing systems, operation of electronic components is prone to external interferences. For instance, operation of a display panel of a computing system may be interfered by an electromagnetic signal from a mobile communication device that may be operating in proximity of the computing system. The interference degrades the performance of the electronic components and may sometimes even stop the functioning of the electronic components.

While electromagnetic wave absorbers are utilized in computing systems to reduce external interference in electronic components, such electromagnetic wave absorbers employ complex circuitry and are expensive to be incorporated in computing systems. Further, induction of electromagnetic wave absorbers in mobile computing systems causes increase in weight and size of the mobile computing systems.

According to example implementations of the present subject matter, techniques for managing interference in operation of electronic components of a computing system are described.

In an example implementation of the present subject matter, if an electromagnetic signal experienced by an electronic component of the computing system is determined as background noise, affecting the operation of the electronic component, the voltage swing across a driver integrated Chip (IC) of the electronic component is increased. The increase in voltage swing across the driver IC increases strength of a signal driving the electronic component. As a result, a signal-to-noise ratio (SNR) associated with the electronic component is improved. This, in turn, reduces the effect of interference on the operation of the electronic component.

As the disruption in the operation of electronic components, such as a display panel of a computing system, is reduced without utilization of electromagnetic wave absorbers, the complexity and the cost associated with interference reduction techniques in computing systems is reduced.

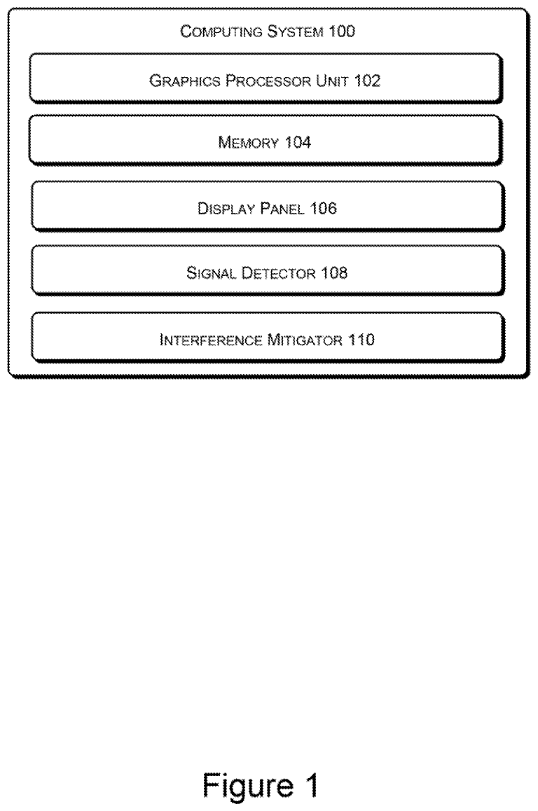

The above techniques are further described with reference to FIG. 1 to FIG. 5. It should be noted that the description and the figures merely illustrate the principles of the present subject matter along with examples described herein, and should not be construed as a limitation to the present subject matter. It is, thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a computing system 100, in accordance with an example implementation of the present subject matter. The computing system may comprise a graphics processor unit 102, a memory 104 coupled to the graphics processor unit 102, a display panel 106 coupled to at least one of the graphics processor unit 102 and the memory 104, a signal detector 108 coupled to the display panel 106, and an interference mitigator 110 coupled to the signal detector 108.

Examples of computing system 100 may include, but not limited to, laptops, desktops, personal digital assistants (PDAs), and tablets. Further, examples of memory 104 may include, but not limited to, any computer-readable medium including, for example, volatile memory (e.g., RAM), and/or non-volatile memory (e.g., erasable programmable read-only memory (EPROM), flash memory, etc.). Moreover, examples of display panel 106 may include, but not limited to, liquid crystal display (LCD) panel, light emitting diode (LED) display panel, organic light-emitting diode (OLED) display panels, and plasma display panel.

In operation, the signal detector 108 may detect an electromagnetic signal experienced by an electronic component of the computing system 100. The signal detector 108 may then determine if the electromagnetic signal is interfering with the operation of the electronic component. The signal detector 108 may determine the electromagnetic signal to be an interference by comparing strength of the electromagnetic signal with a predetermined threshold. If the strength of the electromagnetic signal is found to be greater than the predetermined threshold, the signal detector 108 may determine that the operation of the electromagnetic signal is prone to disruption. That is, if the strength of the electromagnetic signal is found to be greater than the predetermined threshold, the signal detector may also determine that the operation of the electronic component may be disrupted due to the presence of the electromagnetic signal.

Based on the determination, the signal detector 108 may indicate the vulnerability of the electronic component to the interference mitigator 110. The interference mitigator 110 may change different characteristics associated with the electronic component to mitigate the effect of the electromagnetic signal. For example, the signal detector may indicate to the interference mitigator 110 to change characteristics to reduce the interference in a signal being fed to the electronic component.

In an example, the interference mitigator 110 may change a clock power level of the graphics processor unit 102 and the memory 104 to reduce interference in the electronic components. In another example, the interference mitigator 110 may change a clock frequency of the graphics processor unit 102 and the memory 104. The manner in which the above-mentioned techniques reduce the disruption in the operation of the electronic components is further described in detail with respect to explanation of forthcoming Figures,

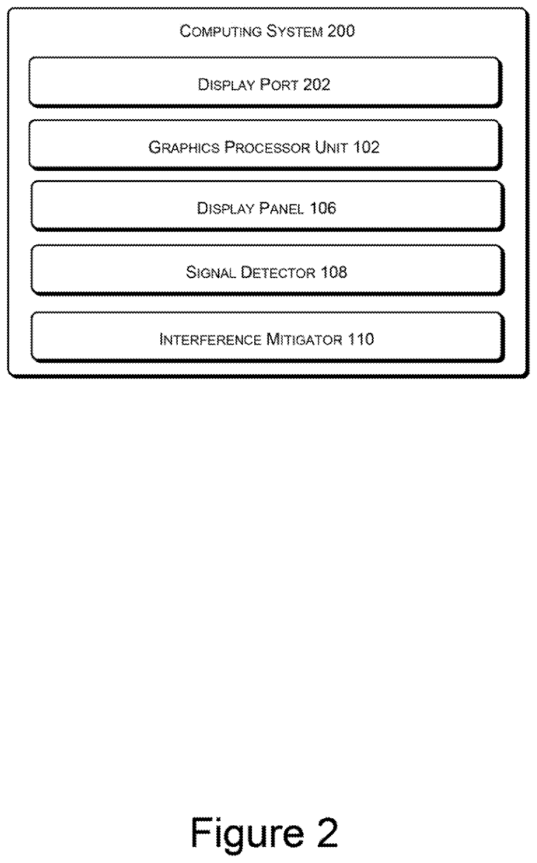

FIG. 2 illustrates a computing system 200, in accordance with an example of the present subject matter. The computing system 200 comprises multiple electronic components that include a display port 202, a graphics processor unit 102 coupled to the display port 202, a display panel 106 coupled to at least one of the display port 202 and the graphics processor unit 102, a signal detector 108, and an interference mitigator 110.

Examples of the display port 202 may include, but not limited to, embedded display port, digital visual interface (DVI), video graphics array (VGA), and High-definition multimedia interface (HDMI). Further, the presence of the coupling between the display port 202 and the graphics processor unit 102 may facilitate transfer of media files received via the display port 202 to the graphics processor unit 102 for processing before the media files are displayed on the display panel 106. Similarly, the coupling between the graphics processor unit 102 and the display panel 106 may facilitate transfer of processed media files from the graphics processor unit 102 to the display panel 106 for display of the media files on the display panel 106.

In operation, the signal detector 108 may detect an electromagnetic signal experienced by the display panel 106. The signal detector 108 may classify the electromagnetic signal as background noise if strength of the electromagnetic signal is above a predetermined threshold. If the electromagnetic signal is classified as the background noise, the signal detector 108 may ascertain that the operation of the display panel 106 is being disrupted by the interference caused by the electromagnetic signal.

Subsequently, the signal detector 108 may indicate a disrupted operational state of the display panel 106 to the interference mitigator 110. The interference mitigator 110 may change characteristics associated with different electronic components of the display panel to reduce the interference caused by the background noise. In an example, the interference mitigator 110 may increase a voltage swing across the display port 202. In another example, the interference mitigator 110 may increase a voltage swing across at least one of a source driver Integrated Chip (IC) (not shown) and a timing controller (not shown) of the display panel 106. In yet another example, the interference mitigator 110 may increase a clock power level of the graphics processor unit 102. The increase in voltage swing across at least one of the display port 202, the source driver IC, and the timing controller increases the strength a signals being transmitted from the above-mentioned electronic components. This, in turn, improves a signal-to-noise ratio (SNR) associated with the electronic components. As a result, the interference in the signals being transmitted from the electronic components is reduced.

Further, an increase in clock power level of the graphics processor unit 102 suppresses any disruption in the operation of the display panel 106 caused due to interference from the electromagnetic signal.

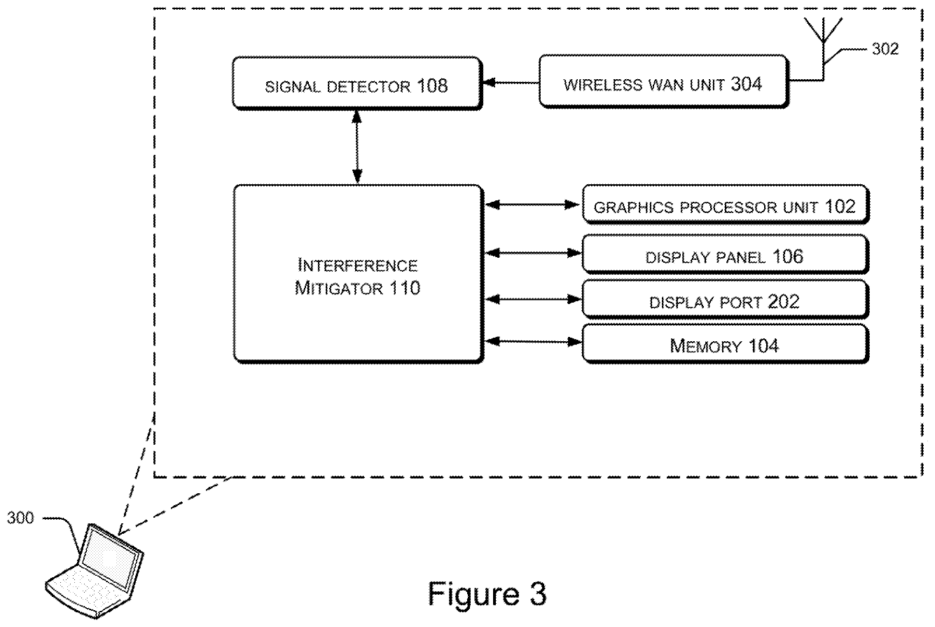

FIG. 3 illustrates a computing system 300, in accordance with yet another example implementation of the present subject matter. The computing system 300 may comprise an antenna 302 to detect electromagnetic signals experienced by the computing system 300, a wireless wide area network (WWAN) module 304 coupled to the antenna 302 a signal detector 108, an interference mitigator 110 coupled to the signal detector 108, a graphics processor unit 102, a display panel 106, a display port 202, and a memory 104, where the graphics processor unit 102, the display panel 106, the display port 202, and the memory 104 are coupled to the interference mitigator 110.

Examples of the antenna 302 may include, but not limited to, inverted-F antenna, folded inverted antenna, and mono pole antenna. In an example, the antenna 302 may be externally coupled to the computing system 200. In another example, the antenna 302 may be 3D printed on a printer circuit board (not shown) of the computing system 300.

In operation, an electromagnetic signal experienced by the computing system 300 may be detected. The electromagnetic signal may then be analysed to determine if the strength of the electromagnetic signal is above a predetermined threshold. The predetermined threshold is a maximum strength of electromagnetic signals that does not disrupt operation of different electronic components of the computing system 300. If the strength of the electromagnetic signal is found to be above the predetermined threshold, it is ascertained that the electromagnetic signal is background noise and may disrupt the operation of the multiple electromagnetic components.

In an example, the antenna 302 may detect an electromagnetic signal experienced by the computing system 300. The detected electromagnetic signal may then be analysed by the WWAN module 304 to determine if strength of the electromagnetic signal lies in a cellular frequency range. As the cellular frequency range varies for different geographical locations, the WWAN module 304 may be configured to operate in different frequencies corresponding to multiple geographical locations. If the determination is found to be true, the WWAN module 304 may categorize the electromagnetic signal to be non-effective to disturb the operation of an electronic components of the computing system 300.

On the other hand, if the WWAN module 304 determines strength of the electromagnetic signal to be beyond the cellular frequency range, the electromagnetic signal may be sent to the signal detector 108. The signal detector 108 may compare the electromagnetic signal to a predetermined threshold to determine if the electromagnetic signal may disrupt the operation of an electronic component of the computing system 300. If the strength of the electromagnetic signal is found to be greater than the predetermined threshold, the signal detector 108 may classify the electromagnetic signal as background noise. Based on the classification, the signal detector 108 may send an indication to the interference mitigator 110 to mitigate the interference caused by the electromagnetic signal.

Based on the indication received from the signal detector 108, the interference mitigator 110 may identify an electronic component of the computing system, operation of which may be disrupted by the electromagnetic signal.

In an example implementation of the present subject matter, the interference mitigator 110 may identify the electronic components that may be affected by the electromagnetic signal. The interference mitigator 110 may compare the strength of the electromagnetic signal with an immune voltage associated with each electronic component of the computing system 300. The immune voltage associated with an electronic component may be defined as a threshold voltage of background noise that may not disrupt the operation of the electronic component. For instance, if the operating voltage of an electronic component is 5 Volts and the electronic component can withstand the background noise of 1 Volt while maintaining its state of operation, the immune voltage of the electronic component is said to be 1 Volt. Accordingly, if the voltage associated with the background noise signal is identified to be greater than or equal to the immune voltage associated with the electronic component, the signal detector may identify the electronic component may be disrupted by the background noise.

Based on the identification of the electronic components which would be affected by the background noise, the interference mitigator 110 may change different characteristics associated with multiple other electronic components to reduce the interference caused by the background noise.

In an example, the interference mitigator 110 may identify the electronic component prone to the background noise to be the display panel 106. Based on the determination, the interference mitigator 110 may change multiple characteristics associated with multiple electronic components, where the multiple electronic components may be associated with controlling the operation of the display panel 106.

In an example, the interference mitigator 110 increases a voltage swing across the display port 202. The display port 202 acts as an interface to feed signals from multiple electronic components of the computing system 300 to the display panel 106. Therefore, as the interference mitigator 110 increases the voltage swing across the display port 202, the Signal-to-Noise Ratio (SNR) associated with the display port 202 of the display panel 106 is improved. As a result, the effect of interference on the signal being fed to the display panel 106 through the display port 202 is reduced. This, in turn, reduces the disruption being observed in the operation of the display panel 106.

In another example, the interference mitigator 110 may increase a voltage swing across a source driver IC (not shown) and a timing controller (not shown) of the display panel 106. Generally, in a display panel, the timing controller provides horizontal and vertical timing signals that drives a source driver IC and a gate driver IC of the display panel. Based on the signals received from the timing controller, the source driver IC and the gate driver IC display media on the display panel. Thus, increasing the voltage swing across the at least one of the timing controller, and the source driver IC and the gate driver IC of the display panel increases the SNR associated with at least one of the timing controller, and the source driver IC and the gate driver IC. As a result, the effect of interference on the signals being transmitted from the timing controller, and the source driver IC and the gate driver IC to the display panel 106 is reduced. This, in turn, reduces the disruption being faced in the operation of the display panel 106.

In yet another example, to reduce the effect of interference on the operation of the display panel 106, the interference mitigator 110 may increase a clock power level of the graphics processor unit 102. An increase in the clock power level of the graphics processor unit 102 avoids any disruption in the operation of the display panel 106 that may be faced due to the interference caused by the electromagnetic signal.

In a further example, the interference mitigator 110 may pre-emphasize a signal that is sent from the graphics processor unit 102 to the display panel 106. The pre-emphasis involves increasing a strength of the signals that are susceptible to noise. As the signal from the graphics processor unit 102 to the display panel 106 is pre-emphasized, the immunity of the signal against external interferences is improved. As a result, the effect of interference on the signal being sent from the graphics processor unit 102 to the display panel 106 is reduced.

Further, in an example, to reduce the effect of interference on the operation of the display panel 106, the interference mitigator 110 may increase a clock power level of the memory 104. An increase in the clock power level of the memory 104 avoids any disruption in the operation of the display panel 106 that may be faced due to the interference caused by the electromagnetic signal.

In yet another example, the interference mitigator 110 may change the clock frequency of the graphics processor unit 102 and the memory 104. Specifically, the interference mitigator 110 decreases the clock frequency of the graphics processor unit 102 and the memory 104 to reduce the disruption in the operation of the display panel 106.

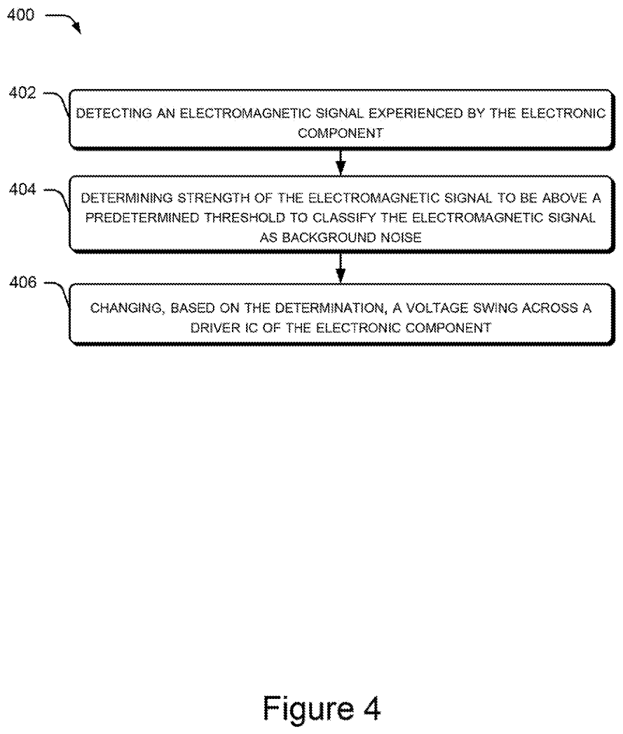

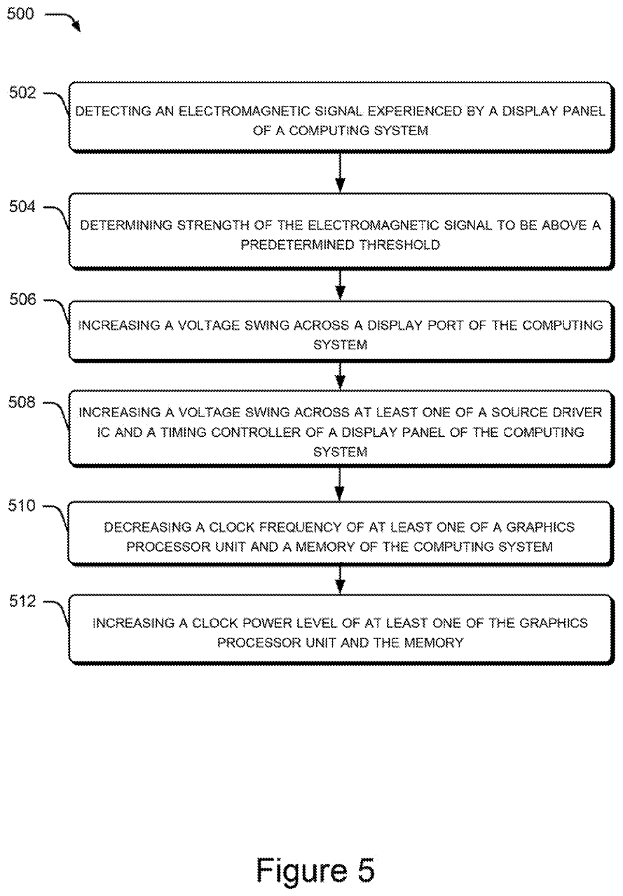

FIG. 4 and FIG. 5 respectively illustrates the methods 400 and 500 for managing interference in operation of an electronic component of a computing system, in accordance with example implementations of the present subject matter. Although the method 400 and 500 may be implemented in a variety of computing devices, but for the ease of explanation, the description of the exemplary methods 400 and 500 is provided in reference to the above-described computing system 300. The order in which the methods 400 and 500 are described is not intended to be construed as a limitation, and any number of the described method blocks may be combined in any order to implement the method 400, or an alternative method.

It may be understood that blocks of the methods 400 and 500 may be performed in the computing system 300. The blocks of the methods 400 and 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, an electromagnetic signal experienced by an electronic component of the computing system 300 is detected. In an example, the electromagnetic signal may be detected by a WWAN module 304 of the computing system 300. The WWAN module 304 may then determine the strength of the electromagnetic signal to be falling within a range of frequencies associated with cellular communication. If the determination is found to be false, the WWAN module 304 may send the strength of the electromagnetic signal to a signal detector 108 of the computing system 300.

At block 404, strength of the electromagnetic signal may be determined to be above a predetermined threshold. In an example, the signal detector 108 may determine the strength of the electromagnetic signal to be above the predetermined threshold. Based on the determination, the signal detector 108 may classify the electromagnetic signal as background noise. The classification of the electromagnetic signal as the background noise may imply that the electromagnetic signal may affect the operation of an electronic component of the computing system 300. Thus, the signal detector 108 may identify the electronic component to be vulnerable to the background noise and may indicate the same to an interference mitigator 110 of the computing system 300.

At block 406, based on the classification of the electromagnetic signal to be background noise, a voltage swing across a driver IC of the electronic component may be changed. In an example, the interference mitigator 110 may change the voltage swing across the driver IC of the electronic component. Specifically, the interference mitigator 110 may increase a voltage swing across the driver IC of the electronic component. An increase in voltage swing across the driver IC increases the magnitude of the input signal being sent from the driver IC to the electronic signal. As a result, a SNR associated with the electronic component may improve, leading to an avoidance of a disruption in operation of the electronic component.

Referring to FIG. 5, the method for managing interference in the operation of a display panel 106 of the computing system 300 is described, in accordance with a comprehensive example implementation of the present subject matter.

At block 502, an electromagnetic signal experienced by the display panel 106 is detected. In an example, a WWAN module 304 of the computing system 300 detects the electromagnetic signal experienced by the display panel.

At block 504, the strength of the electromagnetic signal is determined to be above a predetermined threshold. In an example, a signal detector 108 of the computing system 300 determines the strength of the electromagnetic signal to be above the predetermined threshold.

At block 506, based on the determination of the strength of the electromagnetic signal to be above the predetermined threshold, a voltage swing across a display port 202 of the computing system 300 is increased. In an example, an interference mitigator 110 of the computing system increases the voltage swing across the display port 202. An increase in voltage swing across the display port 202 results in an increase in the strength of a signal being sent from the display port 202 to the display panel 106.

At block 508, a voltage swing across at least one of a timing controller and a source driver IC of the display panel 106 is increased. In an example, the interference mitigator 110 increases the voltage swing across the timing controller and the source driver IC. An increase in voltage swing across the timing controller and the source driver IC increases the strength of a signal being sent from the timing controller and the source driver IC. As a result, the SNR associated with the source driver IC and the timing controller is improved.

At block 510, a clock frequency associated with at least one of the graphics processor unit 102 and a memory 104 of the computing system 300 is decreased. In an example, the interference mitigator 110 decreases the clock frequency to reduce the effect of interference on the operation of the display panel.

At block 512, a clock power level associated of at least one of the graphics processor unit 102 and the memory 104 is increased. The increase in the clock power level of the graphics processor unit 102 and the memory 104 avoids any disruption in the operation of the display panel due to the presence of electromagnetic signal.

Although implementations of the present subject matter have been described in language specific to methods and/or structural features, it is to be understood that the present subject matter is not limited to the specific methods or features described. Rather, the methods and specific features are disclosed and explained as example implementations of the present subject matter.

We claim:

1. A method for managing interference in an electronic component of a computing system, the method comprising:
detecting an electromagnetic signal experienced by the electronic component;
determining strength of the electromagnetic signal to be above a predetermined threshold to classify the electromagnetic signal as background noise; and
changing, based on determination, a voltage swing across a driver integrated chip (IC) of the electronic component.

2. The method as claimed in claim 1, wherein the electronic component is a graphics processor unit, and wherein the method further comprises decreasing a clock frequency of the graphics processor unit.

3. The method as claimed in claim 2, wherein the method further comprises increasing a clock power level of the graphics processor unit.

4. The method as claimed in claim 1, wherein the electronic component is a display panel and wherein changing the voltage swing comprises increasing a voltage swing across a display port of the display panel.

5. The method as claimed in claim 4, wherein changing the voltage swing across the display panel comprises increasing a voltage swing across a source driver IC of the display panel.

6. The method as claimed in claim 4, wherein changing the voltage swing across the display panel further comprises increasing a voltage swing across a timing controller of the display panel.

7. The method as claimed in claim 1, wherein the electronic component is a memory, and wherein the method further comprises increasing a clock power level of the memory.

8. The method as claimed in claim 1 further comprising identifying the electronic component affected by the background noise by comparing the strength of the electromagnetic signal with an immune voltage associated with the electronic component, wherein the immune voltage is a threshold voltage of background noise that does not disrupts operation of the electronic component.

9. A computing system comprising:
a graphics processor unit;
a memory coupled to the graphics processor unit;
a display panel coupled to at least one of the graphics processor unit and the memory;
a signal detector to:
detect an electromagnetic signal experienced by the display panel of the computing system; and
determine strength of the electromagnetic signal to be above a predetermined threshold: and an interference mitigator coupled to the signal detector to:
change, based on determination, at least one of a clock frequency and clock power level of at least, one of the graphics processor unit and the memory.

10. The computing system as claimed in claim 9, wherein to change the clock frequency of the graphics processor unit, the interference mitigator, is to decrease the dock frequency of the graphics processor unit.

11. The computing system as claimed in claim 9, wherein to change the clock power level of the graphics processor unit, the interference mitigator, is to increase the clock power level of the graphics processor unit.

12. The computing system as claimed in claim 9, wherein to change the at least one of the clock power level and the clock frequency of the memory, the interference mitigator, is to increase the clock power level and decreases the clock frequency.

13. A computing system comprising:
a display port;
a graphics processor unit coupled to the display port;
a display panel coupled to the display port and the graphics processor unit;
a signal detector to detect an electromagnetic signal and classify the electromagnetic signal as background noise; and
an interference mitigator coupled to the signal detector to:
increase, based on classification, a voltage swing across the display port;
increase, based on classification, a voltage swing across at least one of a source driver IC and a timing controller of the display panel; and
increase, based on classification, a clock power level of the graphics processor unit.

14. The computing system as claimed in claim 13, wherein the interference mitigator further is to notify the display panel to operate at an increased voltage swing across at least one of the source driver IC and timing, controller.

15. The computing system as claimed in, claim 13, wherein the interference mitigator further is to pre-emphasize a signal sent from the graphics processor unit to the display panel.
